(19) United States
(12) Patent Application Publication
(10) Pub. No.: US 2015/0278936 A1
(43) Pub. Date: Oct. 1, 2015

(54) Consolidated Goal Planning

(71) Applicant: Bank of America Corporation, Charlotte, NC (US)

(72) Inventors: Eric B. Lordi, Branchburg, NJ (US); Eugene M. Mulligan, Charlotte, NC (US); Michael D. Lamb, Gilbert, AZ (US)

(73) Assignee: Bank of America Corporation, Charlotte, NC (US)

(21) Appl. No.: 14/230,793

(22) Filed: Mar. 31, 2014

(51) Int. Cl. G06Q 40/00

(52) U.S. Cl. CPC G06Q 40/00

(57) ABSTRACT

Methods, computer-readable media, systems, and apparatuses for receiving information associated with at least one account of a first user and at least one account of a second user are provided. In some examples, a determination may be made as to whether the first user and the second user have consented to group the at least one account associated with each user. Upon determining that the users have consented, the accounts may be grouped and a common financial goal for the grouped accounts may be determined. The grouped accounts may then be managed toward the common financial goal.

### BACKGROUND

Achieving a financial goal can be a difficult and daunting task. With so many investment options available, determining an appropriate strategy for investing in order to achieve a goal can be overwhelming. Often, individuals might have a common goal but may be investing separately, thereby not taking advantage of the total of all of their assets being invested. Further, although those individuals might have a common goal, he or she may also desire to maintain control of his or her individual investments, accounts, and the like.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, systems, and apparatuses for receiving information associated with at least one account of a first user and at least one account of a second user. A determination may be made as to whether the first user and the second user have consented to group the at least one account associated with each user. Upon determining that the users have consented, the accounts may be grouped and a common financial goal for the grouped accounts may be determined. The grouped accounts may then be managed toward the common financial goal.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 is an illustrative block diagram of workstations and servers that may be used to implement the processes and functions of certain aspects of the present disclosure according to one or more aspects described herein.

FIG. 3 illustrates an example common goal planning system according to one or more aspects described herein.

FIG. 4 is an example method of grouping accounts to be managed toward a common goal according to one or more aspects described herein

FIG. 5 is an example method of grouping accounts and managing the grouped accounts toward a common goal according to one or more aspects described herein.

FIGS. 6-8 illustrate various user interfaces that may be used to input selections or user options related to the grouping of accounts and/or to view account details associated with one or more groups of accounts or grouped accounts

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

It is noted that various connections between elements are discussed in the following description. It is noted that these connections are general and, unless specified otherwise, may be direct or indirect, wired or wireless, and that the specification is not intended to be limiting in this respect.

Aspects of the arrangements described herein relate to creating relationships among one or more accounts of one or more different users. For instance, two or more users may have a common goal or objective when investing. For instance, a husband and wife may be saving for college tuition for one or more children. In another example, three individuals may desire to purchase a vacation home together and are saving toward that end. In another example, two spouses may be saving for retirement with a variety of different retirement assets. Although the users may maintain control of each individual account, the accounts of the multiple parties may be grouped together and managed toward the determined common financial goal. These and various other aspects will be discussed more fully below.

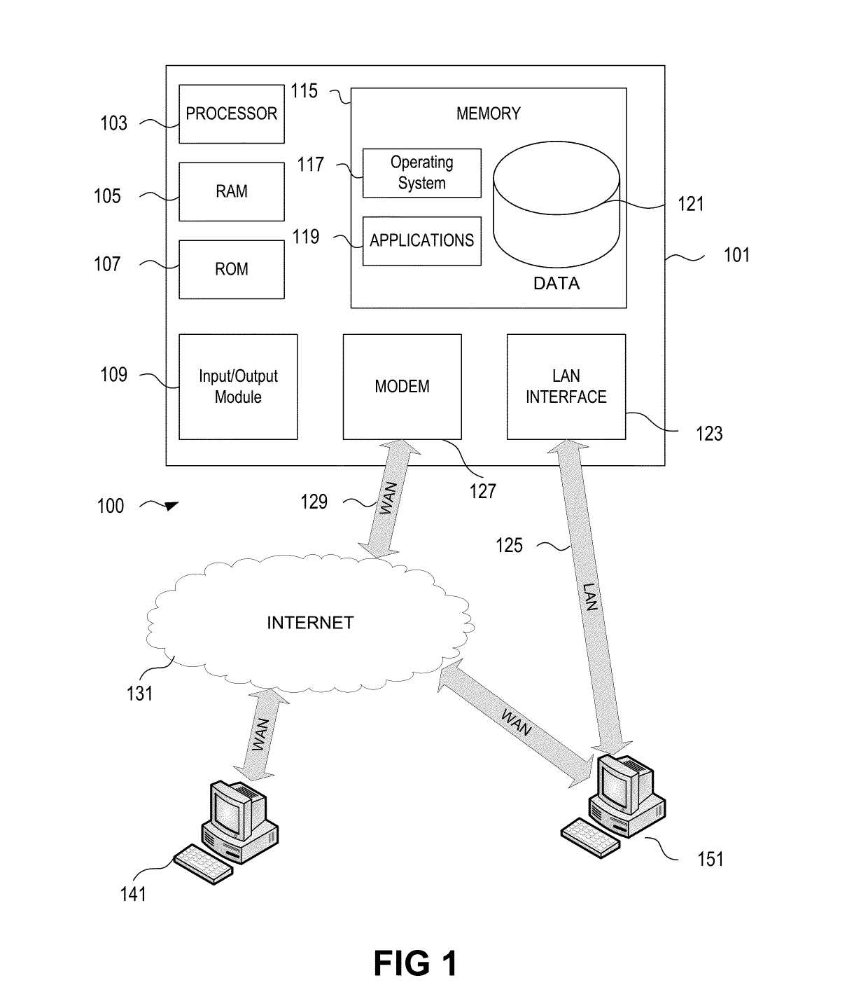

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed arrangements is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141 and 151. Computing devices 141 and 151 may be personal computing devices or servers that include any or all of the elements described above relative to computing device 101. Computing devices 141 or 151 may be a mobile device (e.g., smart phone) communicating over a wireless carrier channel.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

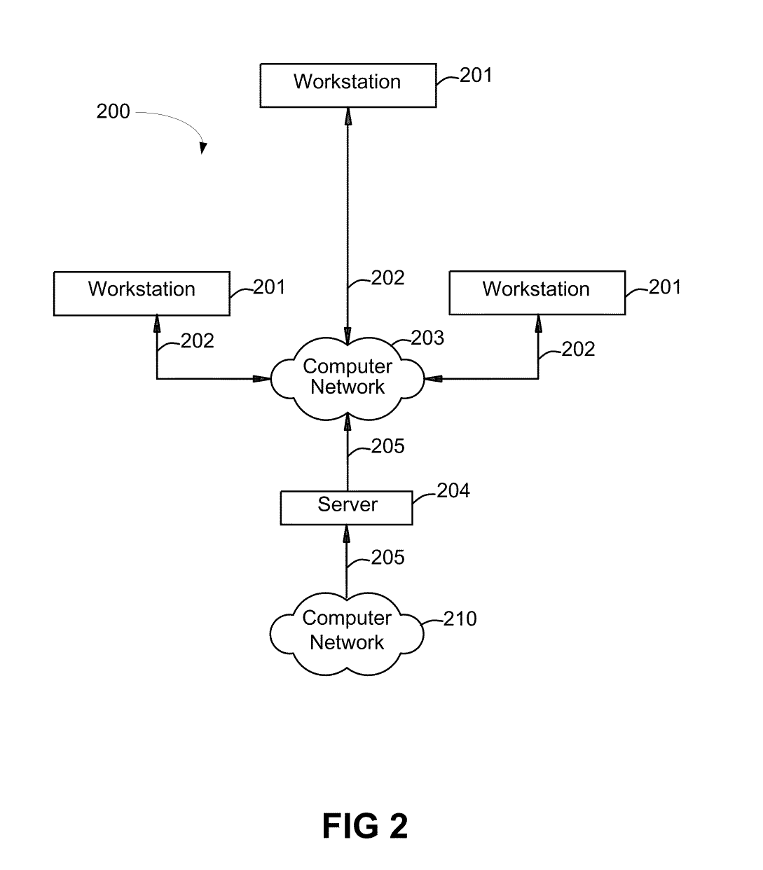

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204 (e.g. network control center), such as network links, dial-up links, wireless links, hard-wired links, as well as network types developed in the future, and the like. A virtual machine may be a software implementation of a computer that executes computer programs as if it were a standalone physical machine.

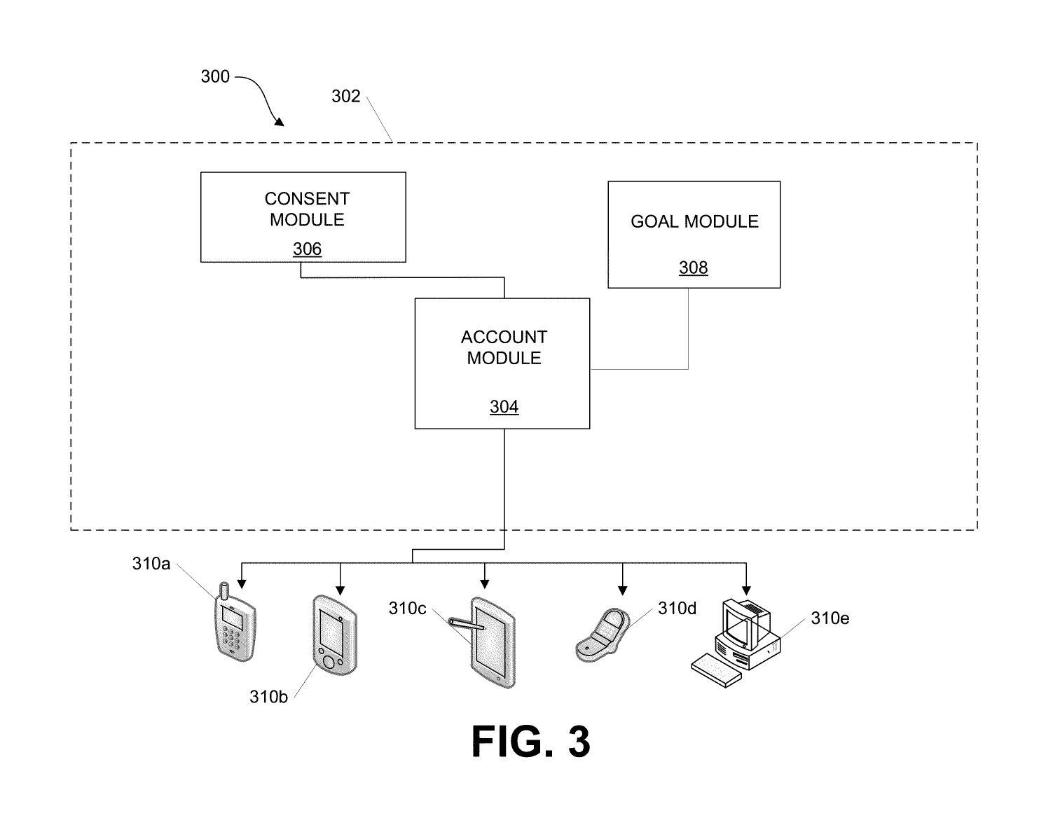

FIG. 3 illustrates one example common goal planning system 300 according to one or more aspects described herein. In some examples, the common goal planning system 300 may be part of, internal to or associated with an entity 302. The entity 302 may be a corporation, university, government entity, and the like. In some examples, the entity 302 may be a financial institution, such as a bank. Although various aspects of the disclosure may be described in the context of a financial institution, nothing in the disclosure shall be construed as limiting the common goal planning system to use within a financial institution. Rather, the system may be implemented by various other types of entities.

The common goal planning system 300 may include one or more modules that may include hardware and/or software configured to perform various functions within the system 300. For instance, each module may include one or more aspects of computing device 101 in FIG. 1 or computing system environment 100 in FIG. 1.

The common goal planning system 300 may include an account module 304. The account module 304 may contain or store (such as in one or more databases) information associated with one or more accounts. For instance, the account module may include account numbers, customer information (e.g., name, address, contact information, and the like) for each customer associated with an account, type of account (e.g., individual retirement account, money market account, savings account, checking account, and the like), goals or goal attributes (e.g., strategy for investing, such as aggressive, conservative, mixed, or the like) associated with the account, and the like. Additional types of account information may be stored within the account module 304 without departing from the invention.

The account module 304 may store accounts individually and may also store, upon request by one or more users, accounts that have been joined or grouped together for the purpose of working toward a common goal. For instance, two or more users (e.g., husband and wife, parent and child, and the like) may each have separate accounts but may have a common goal to work toward (e.g., saving for retirement, new home, college, or the like). Accordingly, one or more individual accounts associated with each user may be grouped together with one or more individual accounts of one or more other users to manage all accounts toward a determined common goal. In some arrangements, the individual accounts grouped together may be various individual accounts of a single user (e.g., a user may have multiple accounts of different types and may have a common goal to work toward. Those accounts may be grouped and managed with an eye toward the common goal.).

In some examples, the account module 304 may be connected to or in communication with a consent module 306. The consent module 306 may include and/or store information associated with consent provided by users associated with various accounts, such as the accounts associated with information stored in account module 304. If, for example, two or more users would like to join or group their accounts to achieve a common goal (e.g., save for retirement, save for sending children to college, and the like) the consent to do so may be stored in consent module 306. For instance, the system may receive input (e.g., from one or more of computing devices 310a-310e) to join multiple accounts for a purpose of working toward a common goal. Upon receiving the input, the system may determine whether consent for the joining was provided by the users by requesting confirmation of the consent from the consent module 306.

In some arrangements, the consent module may store additional consents provided by users. For instance, once two or more accounts of two or more users are joined or grouped for the purpose of working toward the common goal, in some examples, any change to the common goal may require consent of all parties having accounts grouped. That consent may be provided via the consent module 306 (e.g., the consent selections may be made by the users and stored in consent module 306). Additionally or alternatively, one or more of the users having an account that has been joined to or grouped with at least one other account may consent to permit another user having an account that has been joined or grouped to make any modifications to the common goal. Accordingly, if a change is made to the common goal for those accounts that are joined, the system may determine whether the change or modification may be made by determining whether the other users having accounts have either consented to the change or consented to permit the user making the change to modify the common goal without his or her consent.

The common goal planning system 300 may further include a common goal module 308.

The common goal module may include hardware and/or software configured to identify a common goal for user accounts that have been joined. In some examples, the common goal module 308 may determine a common goal for one or more accounts that have been joined. That is, a financial advisor or client may provide general information to the system (e.g., via one or more of computing devices 310a-310e) and the common goal module 308 may, based at least in part on that information, determine a common goal for the joined accounts. In some examples, the common goal module 308 may also manage or make adjustments to one or more accounts within the combined account to work toward the common goal. The goals determined may be general or broad (e.g., save for retirement, save for new home, and the like), may be related to risk (e.g., aggressive investment, conservative investment, or the like), or may include a particular target (e.g., save $X for retirement by date Y, save $A for college needs by date B, and the like).

Further, in some arrangements, the common goal, or one or more attributes of the common goal, may be selected or input by a user. The user may be a holder of one or more accounts within the group. In some examples, the user may be a financial advisor providing counsel to the users having accounts within the group.

These and various other arrangements will be discussed more fully below.

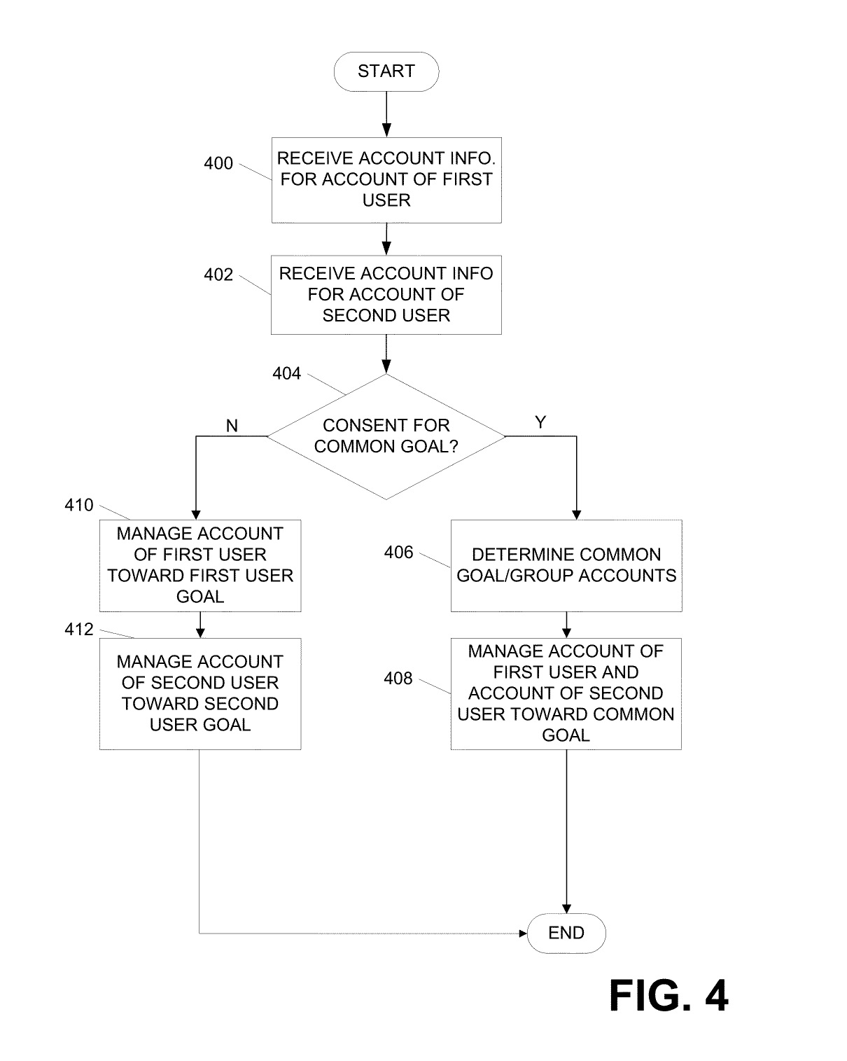

FIG. 4 illustrates one example method of grouping accounts to be managed toward a common goal according to one or more aspects described herein. In step 400, account information for one or more accounts associated with a first user may be received. The account information may include information associated with one or more individual accounts of the first user and may include, for each individual account, a type of account, account number, address information, current balance, and the like. In step 402, account information for one or more accounts associated with a second user may be received. Similar to the information received in step 400, the account information may include information associated with one or more individual accounts of the first user and may include, for each individual account, a type of account, account number, address information, current balance, and the like.

In step 404, a determination is made as to whether both the first user and the second user have provided consent to group the accounts of each user to be managed toward a common goal. In some examples, the determination may be made by querying a database storing consent data (such as a database within consent module 306 in FIG. 3). If, in step 404, both the first user and the second user have provided consent, a common goal may be determined in step 406. As discussed above, the common goal may include specific target amounts to save by a certain date, may include a level of risk to consider when making investments or modifications to one or more accounts to work toward the common goal, and the like. Further, in step 406, the accounts of the first user and the second user associated with the account information received in steps 400 and 402 may be grouped or joined together for the purpose of working toward the common goal.

Grouping or joining the accounts may include providing combined data (e.g., balances, year-to-date earnings, and the like) for a single joined or grouped account. However, each user may still maintain each individual account. That is, the individual accounts of each user are not being combined together into a new account. Rather, the individual accounts are being grouped to be viewed as a single account and may be managed collectively toward the common goal. However, each user may still maintain each individual account and may make modifications to the individual accounts. If, in some instances, a modification made to an individual account would conflict with the common goal, a notification may be transmitted to the user making the modification to indicate the conflict. The notification may, in some examples, be transmitted prior to processing the modification, and may further include various other options that might not conflict with the common goal.

In step 408, the accounts that have been grouped may be managed toward the common goal. Accordingly, investment decisions, and the like, may be made for the accounts collectively to work toward the determined common goal. As indicated above, each user may still maintain the individual accounts associated with the respective user and may make modifications to the individual accounts. However, the grouped accounts will be generally managed together to achieve the common goal.

If, in step 404, it is determined that consent to group the accounts to be managed toward a common goal has not been received, then the individual accounts of the users might not be grouped and, instead, may continue to be managed toward each individual goal. For instance, in step 410, any accounts of the first user may be managed (e.g., investment decisions made and/or implemented) based on the individual goal of the first user. In step 412, any accounts of the second user may be managed toward the individual goal of the second user.

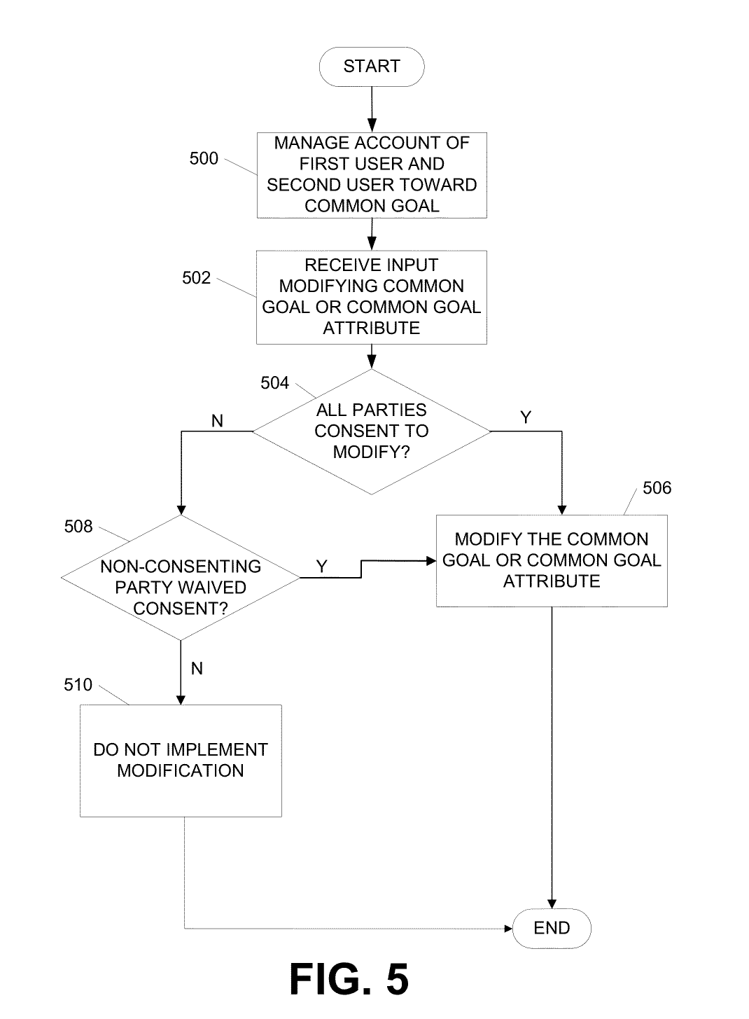

FIG. 5 illustrates an example method of grouping accounts and managing the grouped accounts toward a common goal according to one or more aspects described herein. In step 500, grouped accounts, such as those grouped via the method described with respect to FIG. 4, may be managed toward a determined common goal. In step 502, input may be received (such as via one or more of computing devices 310a-310e in FIG. 3) requesting modification of the common goal or one or more attributes of the common goal. For instance, the common goal may include various attributes such as risk level, time period, liquidity, allocation of assets, and the like. One or more users may request modification of one of those attributes, thereby modifying the common goal.

In step 504, a determination is made as to whether all parties in the group have consented to the requested modification. This may be determined, in some examples, by querying a consent database, such as in module 306 in FIG. 3. If, in step 504, all parties have consented, the common goal or goal attribute may be modified in step 506.

Alternatively, if all parties have not consented to the modification in step 504, a determination may be made in step 508, as to whether the identified non-consenting party has agreed to waive consent. This determination may be made, for example, by querying a database of consent, such as in module 306 in FIG. 3. If, in step 508, the non-consenting party did waive consent, then the modification may be made in step 506. Alternatively, if the non-consenting party did not waive consent, then the requested modification is not implemented in step 510. In some examples, a notification may be transmitted to all parties within the group (e.g., all users having accounts within the group of accounts) indicating that a modification was requested and was not implemented because all parties did not consent.

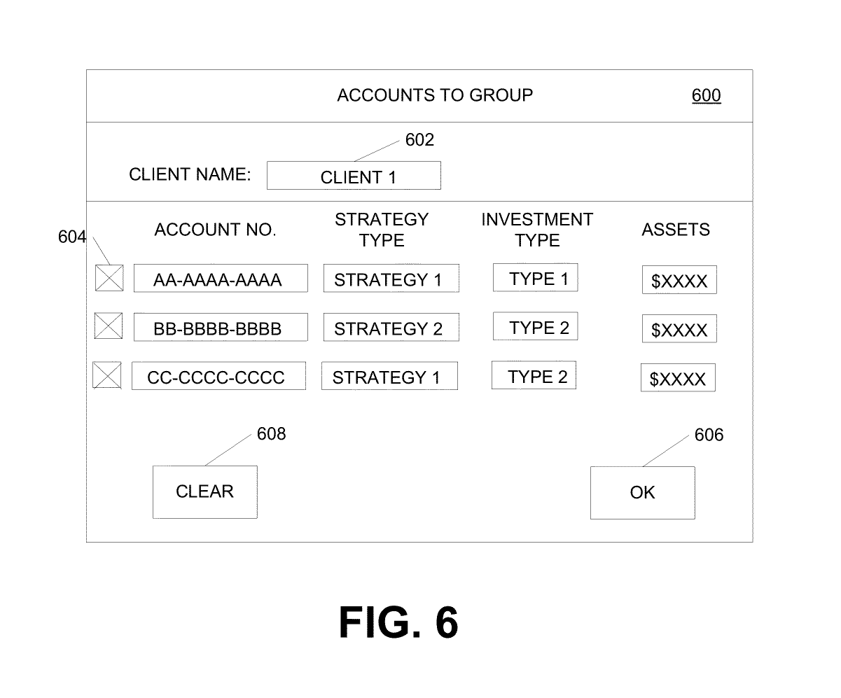

FIGS. 6-8 illustrate various user interfaces that may be used to input selections or user options related to the grouping of accounts and/or to view account details associated with one or more groups of accounts or grouped accounts. For instance, FIG. 6 includes a user interface 600 illustrating various accounts associated with a first user, CLIENT 1, as identified in field 602. Interface 600 includes identification of various accounts associated with CLIENT 1, as well as a strategy type, investment type, and asset total for each account. Each account listed includes a check box, such as check box 604. Selection of the check box associated with an account indicates selection of that account for grouping with additional accounts of CLIENT 1, accounts of one or more other users, or the like. Once the desired accounts for grouping are selected, the user may select “OK” option 606. Alternatively, the user may clear any selections made by selecting “CLEAR” option 608.

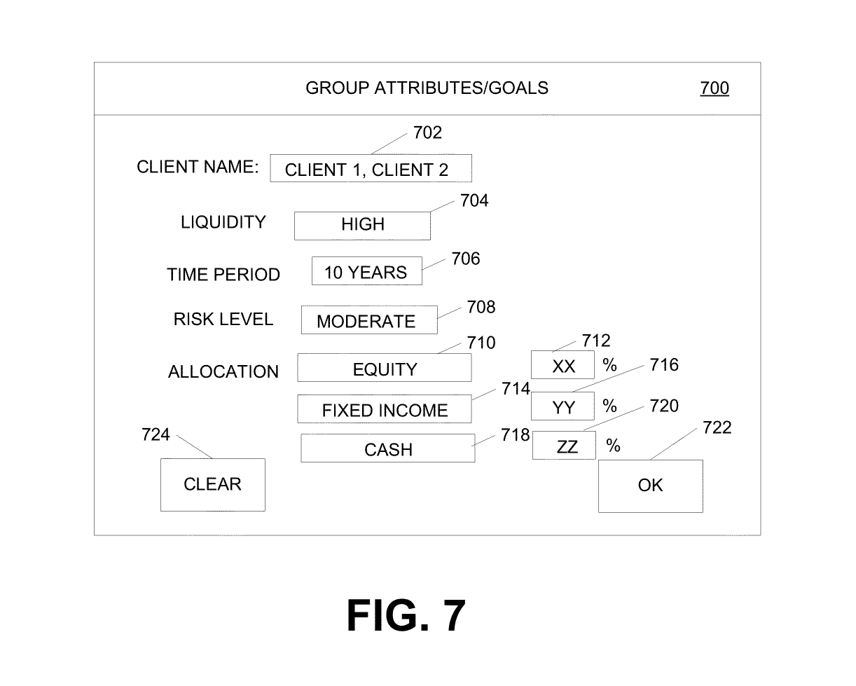

FIG. 7 illustrates one example user interface 700 showing various example goal attributes for the common goal associated with a group of accounts. For instance, the system or, in some examples, an account holder, financial advisor, or the like, may input one or more attributes associated with the goal or goals of the grouped accounts. As shown in FIG. 7, the names of the clients associated with accounts within the group are provided in field 702. Field 704 identifies a desired liquidity for the assets/investments, while field 706 identifies a time period in which it is desirable to meet the common goal of the group. Field 708 identifies a risk level (e.g., high, moderate, low, or the like) which may indicate how aggressive the users wish to be in investing. For instance, if the account holders are saving for retirement and are in their 20's, they may desire higher risk investments, while account holders saving for retirement in their 50's may desire lower risk investments.

Fields 710, 714, and 718 identify the allocation of assets and field 712, 716 and 720 identify respective percentages for each allocation. Once the desired selections are made, a user may select “OK” option 722 to process the selections made. Alternatively, a user may select “CLEAR” option 724 to remove any selections made.

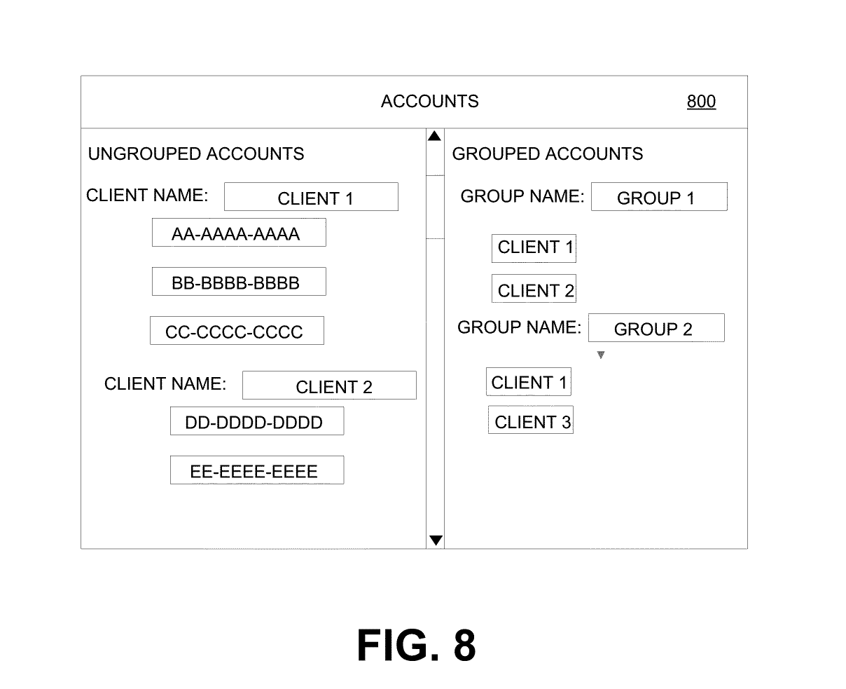

FIG. 8 illustrates one example user interface 800 showing both ungrouped accounts and grouped accounts for a user. For instance, CLIENT 1 may have several individual accounts. Additionally, CLIENT 1 may have grouped accounts with one or more other users. As shown in FIG. 8, CLIENT 1 is grouped with CLIENT 2 in Group 1 and with CLIENT 3 in Group 2. Individual accounts of CLIENT 1 and CLIENT 2 are shown on the left side of the interface 800. A scroll bar may be provided to display information that extends below the visible region of the user interface. For instance, the scroll bar may be used to move down the ungrouped accounts section to display the ungrouped accounts of CLIENT 3.

As discussed herein, grouping one or more accounts of one or more users in order to manage the accounts to achieve a common goal between users provides an efficient way to manage assets and work toward a common goal. Each individual account of each individual user may remain with the individual user (e.g., may be managed, modified, or the like, by the user) but may be considered collectively with the other grouped accounts in determining a strategy to meet the determined common financial goal. Accordingly, the individual still maintains control of the individual account and funds within it, but the accounts and/or funds may be grouped to more broadly work toward the common financial goal.

As discussed herein, the process of efficiently identifying service level agreements running during a particular time period may aid in planning outages, downtime, and the like. In addition, efficiently determining the service level agreements running when an outage occurred may aid in restoring the system quickly and efficiently. Further, identifying the service level agreements running when the outage occurred, as well as the status or progress of each service level agreement, may aid in estimating a time to full recovery or operation of the system. Further, the arrangements described herein may aid in automating some or all aspects of a system recovery by providing a system to identify service level agreements running when an outage occurred, a priority of the service level agreements, and a progress of the service level agreements. The system may then automatically initiate and/or complete a recovery or restoration of the system based on this information.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure. Further, one or more aspects described with respect to one figure or arrangement may be used in conjunction with other aspects associated with another figure or portion of the description.

What is claimed is:

1. An apparatus, comprising:
at least one processor; and
a memory storing computer-readable instructions that, when executed by the at least one processor, cause the apparatus to:
receive information associated with at least one account of a first user;
receive information associated with at least one account of a second user;
determine whether the first user and the second user have consented to group the at least one account of the first user and the at least one account of the second user;
responsive to determining that the first user and the second user have consented to group the at least one account of the first user and the at least one account of the second user, group the at least one account of the first user and the at least one account of the second user and identify a common financial goal for the grouped accounts; and
manage the grouped accounts of the first user and the second user to meet the identified common financial goal of the grouped accounts.

2. The apparatus of claim 1, further including instructions that, when executed, cause the apparatus to:
receive user input from one of the first user and the second user requesting a modification to the common financial goal of the grouped accounts;
determine whether the other of the first user and the second user has consented to the requested modification;
responsive to determining that the other of the first user and the second user has consented to the modification, modify the common financial goal; and
responsive to determining that the other of the first user and the second user has not consented to the modification, notify the first user and the second user of the requested modification and the lack of consent.

3. The apparatus of claim 2, further including instructions that, when executed, cause the apparatus to:
responsive to determining that the other of the first user and the second user has not consented to the modification, determine whether the other of the first user and the second user has waived consent;
responsive to determining that the other of the first user and the second user has waived consent, modify the common financial goal; and
responsive to determining that the other of the first user and the second user has not waived consent, notify the first user and the second user of the requested modification and the lack of consent.

4. The apparatus of claim 1, wherein the common financial goal includes a plurality of goal attributes.

5. The apparatus of claim 1, wherein the plurality of goal attributes include at least two of:
investment risk level, liquidity, time frame, and type of asset.

6. The apparatus of claim 1, wherein the at least one account associated with the first user is configured to be modified without consent from the second user and the at least one account associated with the second user is configured to be modified without consent from the first user.

7. The apparatus of claim 6, further including instructions that, when executed, cause the apparatus to:
determine that a requested modification of the at least one account associated with the first user made by the first user causes a conflict with the common financial goal of the grouped accounts; and
notify the first user and the second user of the conflict prior to processing the requested modification.

8. A method, comprising
receiving, by a common goal planning system including at least one computing device, information associated with at least one account of a first user;
receiving, by the common goal planning system, information associated with at least one account of a second user;
determining, by the common goal planning system, whether the first user and the second user have consented to group the at least one account of the first user and the at least one account of the second user;
responsive to determining that the first user and the second user have consented to group the at least one account of the first user and the at least one account of the second user, grouping, by the common goal planning system, the at least one account of the first user and the at least one account of the second user and identifying, by the common goal planning system, a common financial goal for the grouped accounts; and
managing, by the common goal planning system, the grouped accounts of the first user and the second user to meet the identified common financial goal of the grouped accounts.

9. The method of claim 8, further including:
receiving, by the common goal planning system, user input from one of the first user and the second user requesting a modification to the common financial goal of the grouped accounts;
determining, by the common goal planning system, whether the other of the first user and the second user has consented to the requested modification;
responsive to determining that the other of the first user and the second user has consented to the modification, modifying, by the common goal planning system, the common financial goal; and
responsive to determining that the other of the first user and the second user has not consented to the modification, notifying, by the common goal planning system, the first user and the second user of the requested modification and the lack of consent.

10. The method of claim 9, further including:
responsive to determining that the other of the first user and the second user has not consented to the modification, determining, by the common goal planning system, whether the other of the first user and the second user has waived consent;
responsive to determining that the other of the first user and the second user has waived consent, modifying, by the common goal planning system, the common financial goal; and
responsive to determining that the other of the first user and the second user has not waived consent, notifying, by the common goal planning system, the first user and the second user of the requested modification and the lack of consent.

11. The method of claim 8, wherein the common financial goal includes a plurality of goal attributes.

12. The method of claim 8, wherein the plurality of goal attributes include at least two of: investment risk level, liquidity, time frame, and type of asset.

13. The method of claim 8, wherein the at least one account associated with the first user is configured to be modified without consent from the second user and the at least one account associated with the second user is configured to be modified without consent from the first user.

14. The method of claim 13, further including:
determining, by the common goal planning system, that a requested modification of the at least one account associated with the first user made by the first user causes a conflict with the common financial goal of the grouped accounts; and
notifying, by the common goal planning system, the first user and the second user of the conflict prior to processing the requested modification.

15. One or more non-transitory computer-readable media having computer-executable instructions stored thereon that, when executed, cause at least one computing device to:
receive information associated with at least one account of a first user;
receive information associated with at least one account of a second user;
determine whether the first user and the second user have consented to group the at least one account of the first user and the at least one account of the second user;
responsive to determining that the first user and the second user have consented to group the at least one account of the first user and the at least one account of the second user, group the at least one account of the first user and the at least one account of the second user and identify a common financial goal for the grouped accounts; and
manage the grouped accounts of the first user and the second user to meet the identified common financial goal of the grouped accounts.

16. The one or more non-transitory computer-readable media of claim 15, further including instructions that, when executed, cause the at least one computing device to:
receive user input from one of the first user and the second user requesting a modification to the common financial goal of the grouped accounts;
determine whether the other of the first user and the second user has consented to the requested modification;
responsive to determining that the other of the first user and the second user has consented to the modification, modify the common financial goal; and
responsive to determining that the other of the first user and the second user has not consented to the modification, notify the first user and the second user of the requested modification and the lack of consent.

17. The one or more non-transitory computer-readable media of claim 16, further including instructions that, when executed, cause the at least one computing device to:
responsive to determining that the other of the first user and the second user has not consented to the modification, determine whether the other of the first user and the second user has waived consent;
responsive to determining that the other of the first user and the second user has waived consent, modify the common financial goal; and
responsive to determining that the other of the first user and the second user has not waived consent, notify the first user and the second user of the requested modification and the lack of consent.

18. The one or more non-transitory computer-readable media of claim 15, wherein the common financial goal includes a plurality of goal attributes.

19. The one or more non-transitory computer-readable media of claim 15, wherein the at least one account associated with the first user is configured to be modified without consent from the second user and the at least one account associated with the second user is configured to be modified without consent from the first user.

20. The one or more non-transitory computer-readable media of claim 19, further including instructions that, when executed, cause the at least one computing device to:
determine that a requested modification of the at least one account associated with the first user made by the first user causes a conflict with the common financial goal of the grouped accounts; and
notify the first user and the second user of the conflict prior to processing the requested modification.
